(19) United States
(12) Patent Application Publication
(10) Pub. No.: US 2026/0023060 A1
(43) Pub. Date: Jan. 22, 2026

(54) METHOD FOR DETECTING TARGET SUBSTANCE

(71) Applicant: TAIWAN SEMICONDUCTOR MANUFACTURING COMPANY LTD., HSINCHU (TW)

(72) Inventor: LE LU, NEW TAIPEI CITY (TW)

(21) Appl. No.: 18/773,633

(22) Filed: Jul. 16, 2024

(51) Int. Cl. G01N 31/02

(52) U.S. Cl. CPC G01N 31/02

(57) ABSTRACT

An method for detecting a target substance includes providing a sample including the target substance and an active species, converting the active species into a deactivated species, adding a reactive agent into the sample to form a solid species including the target substance, separating the solid species from the deactivated species by solid-liquid separation, and determining a concentration of the target substance in the sample by measuring a concentration of the target substance in the solid species.

### BACKGROUND

Currently, detection or analysis of the concentration of trace dissolved silicon-based species in chemicals during semiconductor manufacturing processes mostly relies on inductively coupled plasma mass spectrometry (ICP-MS). However, the detection limit of ICP-MS can only reach as low as about 250 ppt. Therefore, there is a need to develop a method for detecting the concentration of trace dissolved silicon-based species with a detection limit lower than that of ICP-MS.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 is a flowchart illustrating a method for detecting a target substance in accordance with embodiments of the present disclosure.

### DETAILED DESCRIPTION

The following disclosure provides many different embodiments, or examples, for implementing different features of the provided subject matter. Specific examples of elements and embodiments are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper,” “on” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, the terms such as “first,” “second” and “third” describe various elements, components, regions, layers and/or sections, but these elements, components, regions, layers and/or sections should not be limited by these terms. These terms may be only used to distinguish one element, component, region, layer or section from another. The terms such as “first,” “second” and “third” when used herein do not imply a sequence or order unless clearly indicated by the context.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the respective testing measurements. Also, as used herein, the terms “substantially,” “approximately” or “about” generally mean within a value or range that can be contemplated by people having ordinary skill in the art. Alternatively, the terms “substantially,” “approximately” or “about” mean within an acceptable standard error of the mean when considered by one of ordinary skill in the art. People having ordinary skill in the art can understand that the acceptable standard error may vary according to different technologies. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the terms “substantially,” “approximately” or “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one endpoint to another endpoint or between two endpoints. All ranges disclosed herein are inclusive of the endpoints, unless specified otherwise.

Embodiments of the present disclosure discuss a method for detecting a target substance in a sample. The sample includes the target substance and an active species. By converting the active species in the sample into a deactivated species and concentrating the target substance into a solid species by coprecipitation to separate the target substance from the deactivated species by solid-liquid separation, the target substance can be isolated and highly concentrated in the solid species regardless of the original amounts or concentration of the active species in the original sample, and thus the measurement sensitivity of the target substance can be increased significantly.

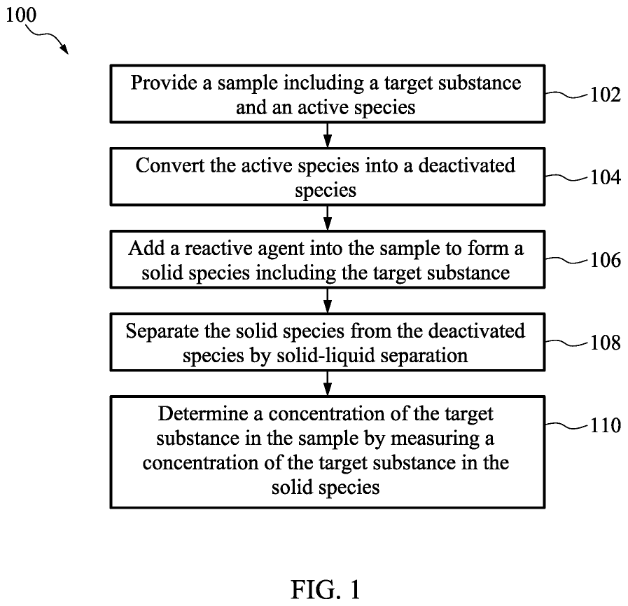

FIG. 1 is a flowchart illustrating a method 100 for detecting a target substance in accordance with embodiments of the present disclosure. The method 100 may be utilized to detect or analyze trace amounts of impurities (i.e., the target substance) in treating solutions during semiconductor manufacturing processes. For example, the treating solutions may be or include cleaning solutions during semiconductor manufacturing processes.

Referring to FIG. 1, the method 100 begins at operation 102 where a sample including the target substance and at least an active species is provided.

In some embodiments, the sample is or includes a solution. In some embodiments, the sample is or includes an aqueous solution. In some embodiments, a concentration of the target substance in the sample or the solution (or the aqueous solution) is less than a concentration of the active species in the sample or the solution (or the aqueous solution). The concentration may be referred to as molarity (or molar concentration) or a weight percent concentration. In some embodiments, the concentration of the target substance in the sample may be less than 1.0 wt %, and the concentration of the active species in the sample may be greater than 20 wt %, e.g., about 20 wt %-30 wt %.

In some embodiments, the target substance is or includes cerium (Ce), aluminum (Al), iron (Fe), lanthanum (La), zirconium (Zr), titanium (Ti), tin (Sn), barium (Ba), strontium (Sr), cobalt (Co), silicon (Si), or a combination thereof. In some embodiments, the target substance is or includes an element selected from the group consisting of Ce, Al, Fe, La, Zr, Ti, Sn, Ba, Sr, Co, and Si. In some embodiments, the target substance includes silica nanoparticles with particle sizes less than about 100 nm, silicone oil, silicates, silanol, or a combination thereof.

In some embodiments, the active species includes one or more organic compounds. In some embodiments, the active species includes an organic compound having one or more chelating functional groups. The active species may have a chelating ability with the target substance. In some embodiments, the active species includes an organic component having a hydroxyl group (—OH), a mercapto group (—SH), an amino group (—NH₂, —NHRx, —NRxRy, wherein Rx and Ry may independently represent an alkyl group), a phosphoryl group (—PO₃, e.g., —P(═O)(—O⁻)(—OH), —P(═O)(—OH)₂), or a combination thereof. In some embodiments, the active species includes alcohol, sulfide, amine, phosphate, or a combination thereof.

The sample or the solution (or the aqueous solution) may be obtained from a treating solution (e.g., a cleaning solution) used during semiconductor manufacturing processes. The active species may be or include the main components or the active elements (e.g., cleaning chemicals) in the treating solution (e.g., a cleaning solution). The target substance may be or include an impurity in the treating solution, e.g., elements other than the main components or the active elements in the treating solution. The target substance may be or include a trace amount of impurity dissolved in the sample or the solution (or the aqueous solution). The target substance may be or include an impurity in the treating solution (e.g., a cleaning solution) used during semiconductor manufacturing processes.

Referring to FIG. 1, the method 100 proceeds to operation 104 by converting the active species into a deactivated species.

In some embodiments, the active species (or the organic compound) is deactivated to form the deactivated species. In some embodiments, the active species (or the organic compound) is deactivated to deactivate the chelating ability of the active species (or the organic compound) with the target substance. In some embodiments, a deactivating agent is added into the sample or the solution (or the aqueous solution) to react with the active species to form the deactivated species in the sample or the solution (or the aqueous solution). In some embodiments, a deactivating agent is added into the sample or the solution (or the aqueous solution) to react with the chelating functional group of the active species to form the deactivated species in the sample or the solution (or the aqueous solution).

In some embodiments, the deactivating agent includes an alkylating agent, an acylating agent, an acetalizing agent, or a combination thereof. The active species may include alcohol, sulfide, amine, phosphate, or a combination thereof that may be independently deactivated by alkylation, acylation, acetalization, or a combination thereof.

In some embodiments, the alkylating agent may include dimethyl sulfate, diethyl sulfate, dimethyl carbonate, diethyl carbonate, methyl iodide, ethyl bromide, benzyl chloride, benzyl bromide, or a combination thereof. In some embodiments, the alkylating agent may include at least a structure represented by at least one of the following formulae (1) to (3):

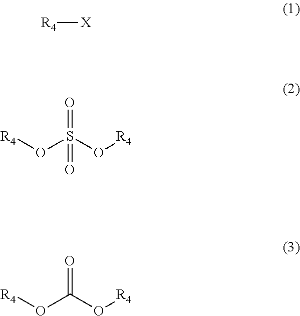

Each of R₄ independently represents a benzyl group or an alkyl group having a carbon number from 1 to 4, and the alkyl group may include at least one of methyl, ethyl, n-propyl, i-propyl, n-butyl, iso-butyl, sec-butyl, tert-butyl, and benzyl. X represents fluoride, chloride, bromide, iodide, sulfate, or carbonate.

In some embodiments, the active species, which may be or include alcohol, sulfide, amine, and/or phosphate, may be deactivated by the alkylating agent by at least one of the reactions represented by the following reaction formulae (I-1) to (I-4):

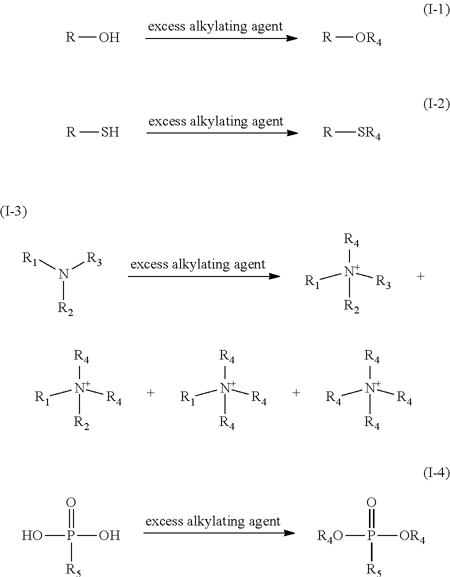

The alkylating agent may include at least a structure represented by at least one of the above formulae (1) to (3). R, R₁, R₂, and R₃ independent represent hydrogen, an alkyl group having a carbon number from 1 to 18, a phenyl group, or a benzyl group. R₅ represents an alkyl group having a carbon number from 1 to 12, which may optionally contain multifunctional groups including a hydroxyl group (—OH), a mercapto group (—SH), an amino group (—NRxRy, wherein Rx and Ry may independently represent hydrogen or an alkyl group), a phosphoryl group (—PO₃, e.g., —P(═O)(—O⁻)(—OH), —P(═O)(—OH)₂), or a combination thereof.

In some embodiments, a molar ratio of an amine type active species to the alkylating agent is from 3 to 12 or from 4 to 10. In some embodiments, a molar ratio of a primary amine type active species to the alkylating agent is equal to or greater than 1, e.g., from 1.2 to 4 or from 1.5 to 3.5. In some embodiments, a molar ratio of a secondary amine type active species to the alkylating agent is equal to or greater than 2, e.g., from 2.2 to 8 or from 2.5 to 6. In some embodiments, a molar ratio of a tertiary amine type active species to the alkylating agent is equal to or greater than 3, e.g., from 3.5 to 12 or from 4 to 10. In some embodiments, the amine type active species is deactivated by alkylating all amino (—NH) sites with the alkylating agent.

In some embodiments, a molar ratio of an alcohol type active species to the alkylating agent is equal to or greater than 1, e.g., from 1.2 to 3 or from 2 to 5. In some embodiments, a molar ratio of a sulfide type active species to the alkylating agent is equal to or greater than 1, e.g., from 1.2 to 3 or from 2 to 5. In some embodiments, a molar ratio of a phosphate type active species to the alkylating agent is equal to or greater than 2, e.g., from 2 to 5. In some embodiments, the alcohol type active species and the phosphate type active species may be deactivated by alkylating all hydroxyl sites (—OH) with the alkylating agent. In some embodiments, the sulfide type active species may be deactivated by alkylating all mercapto sites (—SH) with the alkylating agent.

In some embodiments, the acylating agent may include acetyl chloride, acetyl bromide, benzyl chloride, benzyl bromide, carboxylic acid anhydride, or a combination thereof. In some embodiments, the acylating agent may include at least a structure represented by at least one of the following formulae (4) and (5):

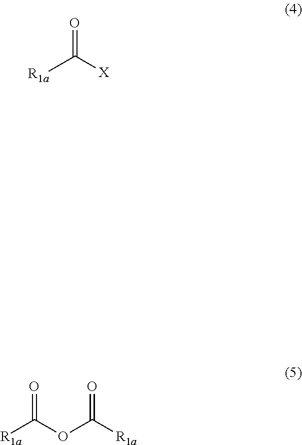

R₁ₐ represents a phenyl group, a benzyl group, or an alkyl group having a carbon number from 1 to 4, and the alkyl group may include at least one of methyl, ethyl, n-propyl, i-propyl, n-butyl, iso-butyl, sec-butyl, tert-butyl, phenyl and benzyl. R₁ₐ may represent an alkyl group having a carbon number from 1 to 3, which may optionally contain multifunctional groups including a hydroxyl group (—OH), a mercapto group (—SH), an amino group —NRxRy, wherein Rx and Ry may independently represent hydrogen or an alkyl group), a phosphoryl group (—PO₃, e.g., —P(═O)(—O⁻)(—OH), —P(═O)(—OH)₂), or a combination thereof. X represents fluoride, chloride, bromide, iodide, sulfate, or carbonate.

In some embodiments, the active species, which may be or include alcohol, sulfide, amine, and/or phosphate, may be deactivated by the acylating agent (e.g., excess acylating agent) by at least one of the reactions represented by the following reaction formulae (II-1) to (II-9):

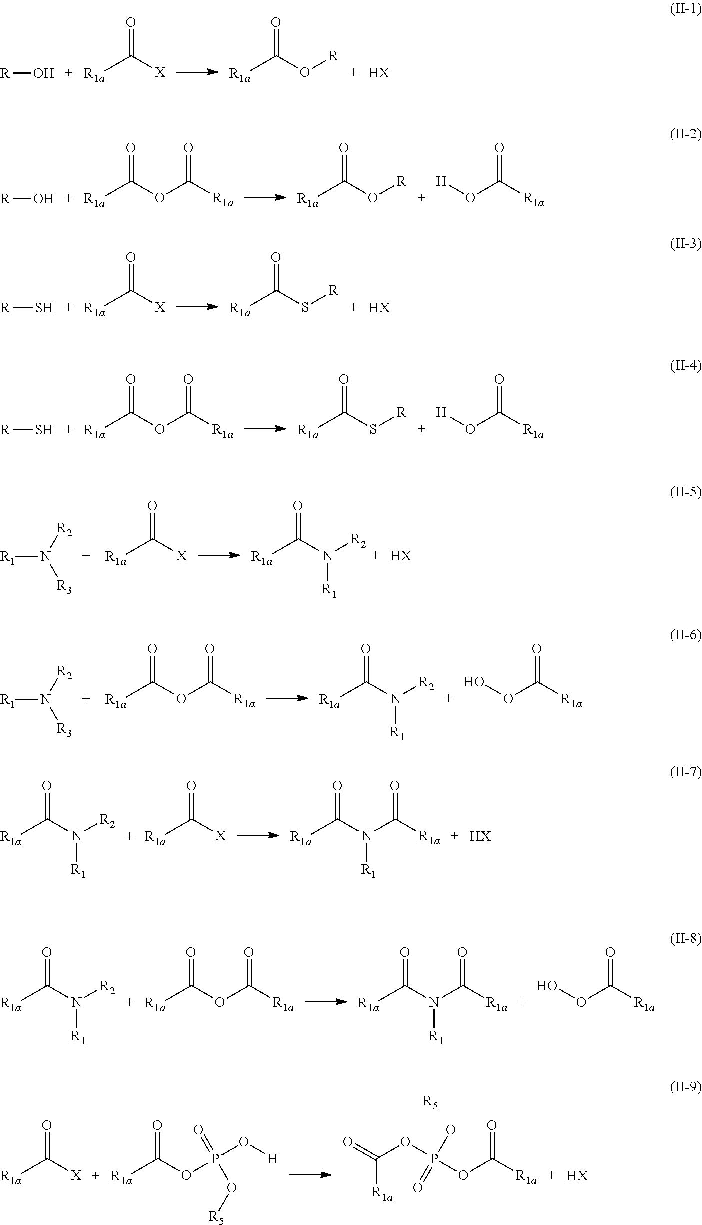

The acylating agent may include at least a structure represented by at least one of the above formulae (4) and (5). The product of the acylation reaction represented by reaction formula (II-5) may be further acylated as represented by reaction formula (II-7). The product of the acylation reaction represented by reaction formula (II-6) may be further acylated as represented by reaction formula (II-8).

In some embodiments, the acylating agent may also undergo a side reaction represented by the following reaction formula (II-10):

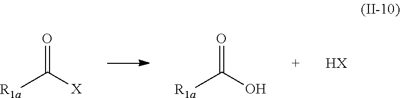

In some embodiments, a molar ratio of an amine type active species to the acylating agent is equal to or greater than 1, e.g., from 1.2 to 5. In some embodiments, the amine type active species is deactivated by acylating at least one amino (—NH) site with the acylating agent.

In some embodiments, a molar ratio of an alcohol type active species to the alkylating agent is equal to or greater than 1, e.g., from 1.2 to 3 or from 2 to 5. In some embodiments, a molar ratio of a sulfide type active species to the alkylating agent is equal to or greater than 1, e.g., from 1.2 to 3 or from 2 to 5. In some embodiments, a molar ratio of a phosphate type active species to the alkylating agent is equal to or greater than 2, e.g., from 2 to 5. In some embodiments, the alcohol type active species and the phosphate type active species may be deactivated by alkylating all hydroxyl sites (—OH) with the alkylating agent. In some embodiments, the sulfide type active species may be deactivated by alkylating all mercapto sites (—SH) with the alkylating agent.

In some embodiments, the acylating agent (e.g., acryl halide) may react with water and produce carboxylic acid as a side reaction that consumes the acylating agent. As such, the molar ratio of the amine type active species, the alcohol type active species, and the sulfide type active species to the acylating agent is preferably greater than 1, e.g., from 1.2 to 5. In addition, the molar ratio of the phosphate type active species to the acylating agent is preferably greater than 2, e.g., from 2 to 5.

In some embodiments, the acetalizing agent may include formaldehyde, acetaldehyde, polyoxymethylene, 1,3,5-trioxane, paraldehyde, 2,2-dimethoxypropane, or a combination thereof. In some embodiments, the acetalizing agent may include a structure represented by at the following formula (6):

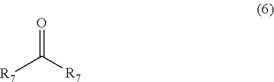

R₇ represents hydrogen (—H) or methyl group (—CH₃).

In some embodiments, the active species, which may be or include one or more hydroxyl groups, may be deactivated by the acetalizing agent (e.g., excess acetalizing agent) by at least one of the reactions represented by the following reaction formulae (III-1) to (III-2):

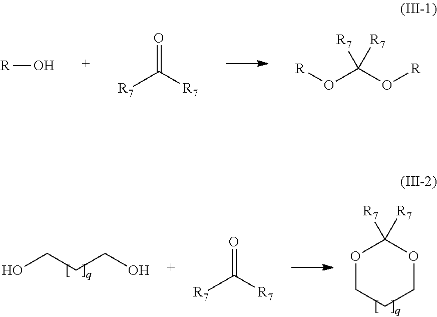

The acetalizing agent may include a structure represented by the above formula (6). q is an integer from 1 to 10.

In some embodiments, the acetalizing agent may also undergo a side reaction represented by the following reaction formula (III-3):

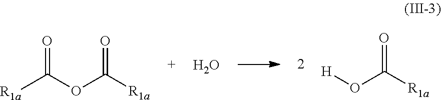

In some embodiments, a molar ratio of an amine type active species to the acetalizing agent is equal to or greater than 1, e.g., from 1.2 to 4. In some embodiments, the amine type active species is deactivated by acetalizing at least one amino (—NH) site with the acetalizing agent.

In some embodiments, a molar ratio of an alcohol type active species to the acetalizing agent is equal to or greater than 1, e.g., from 1.2 to 5. In some embodiments, a molar ratio of a sulfide type active species to the alkylating agent is equal to or greater than 1, e.g., from 1.2 to 5. In some embodiments, a molar ratio of a phosphate type active species to the alkylating agent is equal to or greater than 1, e.g., from 1.2 to 5. In some embodiments, the alcohol type active species may be deactivated by acetalizing the hydroxyl site (—OH) with the acetalizing agent. In some embodiments, the phosphate type active species may be deactivated by dehydrating the hydroxyl groups to form an oxygen-containing heterocyclic compound with the acetalizing agent.

In some embodiments, the acetalizing agent (e.g., anhydride) may react with water and produce carboxylic acid as a side reaction that consumes the acetalizing agent. As such, the molar ratio of the amine type active species, the alcohol type active species, the sulfide type active species and the phosphate type active species to the acetalizing agent is preferably greater than 1, e.g., from 1.2 to 5.

According to some embodiments of the present disclosure, the active species in the sample or the solution (or the aqueous solution) are deactivated for deactivating the chelating ability of the active species (or the organic compound). As such, the as-formed deactivated species is unable to chelate with the target substance and other reactive agents. Therefore, the target substance is available to react with reactive agents instead of chelating with the active species, and thus the interference of the active species to subsequent reactions of the target substance can be eliminated.

Referring to FIG. 1, the method 100 proceeds to operation 106 by adding a reactive agent (or a compound) into the sample or the solution (or the aqueous solution) to form a solid species including the target substance.

In some embodiments, the reactive agent is substantially reactive with the target substance. In some embodiments, the reactive agent is substantially non-reactive with the deactivated species. In some embodiments, the reactive agent is substantially reactive with the active species. The reactive agent may include one or more elements that may react with the target substance to form the solid species.

In some embodiments, the solid species is formed by coprecipitating the solution or the aqueous solution (i.e., the sample). In some embodiments, the solid species including the target substance is formed by coprecipitating the solution or the aqueous solution (i.e., the sample).

In some embodiments, the target substance includes a first element, coprecipitating the solution includes adding a compound (e.g., the reactive agent) including a second element different from the first element into the solution or the aqueous solution, and the first element and the second element independently include elements selected from the group consisting of Ce, Al, Fe, La, Zr, Ti, Sn, Ba, Sr, Co, and Si.

In some embodiments, the target substance includes Si, and the reactive agent includes a metal salt including a metal selected from the group consisting of Ce, Al, Fe, La, Zr, Ti, Sn, Ba, Sr, and Co. In some embodiments, the metal salt further includes an anion. The anion may include nitrate, sulfate, fluoride, chloride, bromide, iodide, borate, acetate, triflate, or a combination thereof. In some embodiments, coprecipitating the solution or the aqueous solution includes adding a metal salt into the solution or the aqueous solution, and the metal salt includes a metal selected from the group consisting of Ce, Al, Fe, La, Zr, Ti, Sn, Ba, Sr, and Co. In some embodiments, the sample is or includes an aqueous solution, coprecipitating the aqueous solution includes adding the above-mentioned metal salt into the aqueous solution, and the metal salt includes a water soluble anion. The water soluble anion may be or include nitrate, sulfate, fluoride, chloride, bromide, iodide, borate, acetate, triflate, or a combination thereof. The reactive agent may further include a solvent (e.g., water and/or alcohol) in which the metal salt is dissolved.

In some embodiments, the target substance includes Si, and the reactive agent includes a metal hydroxide including a metal selected from the group consisting of Ce, Al, Fe, La, Zr, Ti, Sn, Ba, Sr, and Co. In some embodiments, coprecipitating the solution or the aqueous solution includes adding a metal hydroxide into the solution or the aqueous solution, and the metal hydroxide includes a metal selected from the group consisting of Ce, Al, Fe, La, Zr, Ti, Sn, Ba, Sr, and Co. The reactive agent may further include a solvent (e.g., water and/or alcohol) in which the metal hydroxide is dissolved. In some embodiments, the sample is or includes an aqueous solution, coprecipitating the aqueous solution includes adding the above-mentioned metal hydroxide into the aqueous solution.

In some embodiments, the reactive agent may be in an amount of less than about 1.0 wt % of the sample or the solution (or the aqueous solution). In some embodiments, the reactive agent may be in an amount of 0.01 to 1.0 wt % of the sample or the solution (or the aqueous solution). In some embodiments, the reactive agent may be in an amount of excess of the amount or concentration of the target substance in the sample or the solution (or the aqueous solution).

In some embodiments, the sample or the solution (or the aqueous solution) may be cooled down. In some embodiments, the temperature of the sample or the solution (or the aqueous solution) is lowered during the coprecipitating. In some embodiments, the temperature of the sample or the solution (or the aqueous solution) is lowered to a predetermined relatively low temperature (e.g., lower than room temperature) during the coprecipitating. Cooling down may facilitate the coprecipitating process for forming the solid species including the target substance. In some embodiments, the sample or the solution (or the aqueous solution) is cooled down to a temperature lower than about 10° C. In some embodiments, the sample or the solution (or the aqueous solution) is cooled down to a temperature about 0° C.

In some embodiments, an organic solvent is added into the aqueous solution of the sample when cooling down. In some embodiments, the organic solvent remains in a liquid state when cooling down the aqueous solution. In some embodiments, the organic solvent allows the aqueous solution in a liquid state when cooling down the aqueous solution. In some embodiments, a cryosolvent is added into the solution. In some embodiments, the cryosolvent remains in a liquid state when lowering the temperature of the solution or the aqueous solution during the coprecipitating. In some embodiments, the organic solvent may be referred to as the cryosolvent. The cryosolvent (or the organic solvent) may include ethanol.

In some embodiments, the target substance is concentrated by coprecipitating the sample or the solution (or the aqueous solution). In some embodiments, the target substance is concentrated by coprecipitating the sample or the solution (or the aqueous solution) to form the solid species including the target substance. In some embodiments, the target substance is concentrated by coprecipitating to form the solid species including the target substance and substantially free of the deactivated species (or the deactivated organic compound). In some embodiments, concentrating the target substance is free of evaporating the sample or the solution (or the aqueous solution).

According to some embodiments of the present disclosure, the reactive agent reacts with the target substance to form a solid species including the target substance while the active species has been deactivated to form the deactivated species that is substantially non-reactive with the reactive agent. Therefore, the interference of the chelating ability of the active species to the reaction between the target substance and the reactive agent can be eliminated, and thus the as-formed solid species including the target substance can be substantially free of the active species. Accordingly, the target substance can be isolated from the active species, and thus the concentration of the target substance can be measured independently of the active species.

In addition, according to some embodiments of the present disclosure, the cryosolvent is or includes an organic solvent. Therefore, the cryosolvent can not only provide a relatively low temperature facilitating the coprecipitation but also increase the solubility of the deactivated species (e.g., organic compound) in the liquid portion of the sample or the solution (or the aqueous solution). Therefore, the separation or isolation of the target substance in the solid species from the deactivated species is further improved.

Referring to FIG. 1, the method 100 proceeds to operation 108 by separating the solid species from the deactivated species by solid-liquid separation.

In some embodiments, the solid species is separated from the liquid portion of the sample or the solution (or the aqueous solution) by centrifuge or filtration (e.g., ultrafiltration). In some embodiments, the deactivated species is in the liquid portion of the sample or the solution (or the aqueous solution), and the solid species including the target substance is separated from the deactivated species in the liquid portion of the sample by solid-liquid separation (e.g., centrifuge or ultrafiltration).

Referring to FIG. 1, the method 100 proceeds to operation 110 by determining a concentration of the target substance in the sample by measuring a concentration of the target substance in the solid species.

In some embodiments, the solid species is dissolved in a solvent, and then the concentration of the dissolved target substance is detected. In some embodiments, the solvent is or includes an aqueous solution. In some embodiments, the solvent is or includes an acid solution, e.g., a hydrofluoric acid (HF) solution. In some embodiments, the solid species is dissolved in an acid solution, e.g., an acid solution including HF. In some embodiments, the concentration of the target substance dissolved in the acid solution is then measured. In some embodiments, the concentration of the target substance dissolved in the acid solution is measured by ICP-MS, ICP-OES, GFAA, or any combination thereof. In some embodiments, the concentration of the target substance in the original sample or the solution (or the aqueous solution) is then obtained or determined by calculation based on the concentration of the target substance in the solid species and the volume of the original sample or the solution (or the aqueous solution).

In some cases where a sample (e.g., obtained from a treating solution) includes active species (or main components) and a trace amount of impurities and there is a need to determine the concentration of the impurities in the sample, evaporation may be used to concentrate the sample in order to increase the detected concentration of the impurities. However, since the concentration of the active species (or the main components) is a lot greater than that of the impurities, the increase in the concentration of the impurities may be limited since evaporation may also increase the concentration of the active species significantly to a concentrated limit of the active species. As such, even after the evaporation, the concentration of the impurities may be still relatively low while the concentration of the active species has reached its highest limit, and thus the measurement sensitivity of the impurities is still relatively low.

According to some embodiments of the present disclosure, the reactive agent reacts with the target substance to form a solid species including the target substance while the active species has been deactivated to form the deactivated species and separated from the target substance. Therefore, the target substance in the solid species can be isolated from the active species, and thus the concentration of the target substance can be measured independently of the active species. With the target substance that is included in the solid species and successfully separated from the active species, the concentration of the target substance can be obtained directly from measuring the concentration of the target substance in the solid species without interference from the active species, thus the measurement sensitivity of the target substance can be increased significantly.

In addition, according to some embodiments of the present disclosure, the solid species is formed by coprecipitating a reactive agent with the target substance, thus the target substance is concentrated significantly by the coprecipitation. That is, the trace amount of the target substance in the original sample can be collected into the solid species by coprecipitation, and the large amount of the active species and the solvent from the original sample can be isolated or removed from the target substance collected in the solid species. Therefore, the target substance can be isolated and highly concentrated in the solid species regardless of the original amounts or concentration of the active species in the original sample, and thus the measurement sensitivity of the target substance can be increased significantly.

Moreover, according to some embodiments of the present disclosure, the highly concentrated target substance is in a solid state in the solid species while the deactivated species is soluble in the liquid that is separated from the solid species. As such, the target substance can be not only highly concentrated by the coprecipitation but also casily separated from the deactivated species by solid-liquid separation technique, e.g., centrifuge or filtration. Therefore, the process for the analysis or detection of the trace amount of the target substance can be simplified significantly.

Furthermore, since the detection limit of ICP-MS can only reach as low as about 250 ppt, when an ICP-MS measurement is performed on a sample including a trace amount of the target substance and directly dissolved in an acid solution (i.e., the sample further diluted in the acid solution), the signal intensity of the ICP-MS may be relatively low or even below the detection limit. In contrast, according to some embodiments of the present disclosure, the solid species including the concentrated target substance can be dissolved in a relatively small amount of acid solution (e.g., solution containing HF) for ICP-MS measurements. Therefore, the signal intensity of the ICP-MS can be increased compared to that obtained from measuring the original sample directly dissolved in an acid solution. For example, the signal intensity can be increased from about 10 to 100 times, e.g., from about 250 ppt to about 2.5 ppt. Accordingly, the measurement accuracy can be increased as well.

Presented below are examples of detection of trace amounts of target substances using the method according to some embodiments of the present disclosure.

### EXAMPLE 1

100 mL of an aqueous solution (original sample) containing monoethanolamine (MEA) and an unknown amount of silicon clement is cooled in an ice bath. When the temperature of the aqueous solution (or the sample) reaches 0° C., excess diethyl sulfate (3-6 equivalents with respect to 1.0 equivalent of MEA) is added into the solution dropwise with continuously stirring. The mixture is then removed from the ice bath, and the reaction continues at room temperature for 30 minutes. After the reaction is completed, the solution is then acidified to pH 3 with diluted sulfuric acid and then monitored by a non-glass type pH meter such as ion sensitive field effect transistor (ISFET) semiconductor probe. Next, 5 mL of an aqueous solution including 100 mg of cerium (IV) sulfate is added in the acidified solution, and then diluted potassium hydroxide solution is added to tune the pH value of the solution to pH 8.0 with continuously stirring for 10 minutes to form a suspension in the solution. The solution including the suspension is centrifuged for 10 minutes with a 5000-g force, the upper liquid portion is then descanted, the remained precipitate is dissolved with diluted hydrofluoric acid (HF), and general procedure of ICP-MS, ICP-OES, or GFAA analysis is performed to measure the concentration of silicon element in the precipitate. Finally, the original concentration of silicon element in the original sample is obtained by calculation based on the concentration of the silicon element in the precipitate and the dilution ratio thereof.

In the above Example 1, MEA is the active species in the sample, silicon element is the target substance to be detected, diethyl sulfate serves to deactivate MEA, cerium (IV) sulfate serves to co-precipitate the silicon element into the precipitate (or the solid species), and the deactivated species of MEA is dissolved in the upper liquid portion that is descanted.

### EXAMPLE 2

100 mL of an aqueous solution (original sample) containing monoethanolamine (MEA) and an unknown amount of silicon clement is cooled in an ice bath. When the temperature of the aqueous solution (or the sample) reaches 0° C., excess iodomethane (5-6 equivalents with respect to 1.0 equivalent of MEA) is added into the solution dropwise with continuously stirring. The mixture is then removed from the ice bath, and the reaction continues at room temperature for 30 minutes. After the reaction is completed, the solution is then acidified to pH 3 with diluted sulfuric acid and then monitored by a non-glass type pH meter such as ion sensitive field effect transistor (ISFET) semiconductor probe. Next, 5 mL of an aqueous solution including 100 mg of ferric chloride is added in the acidified solution, and then diluted potassium hydroxide solution is added to tune the pH value of the solution to pH 8.0 with continuously stirring for 10 minutes to form a suspension in the solution. The solution including the suspension is centrifuged for 10 minutes with a 5000-g force, the upper liquid portion is then descanted, the remained precipitate is dissolved with diluted hydrofluoric acid (HF), and general procedure of ICP-MS, ICP-OES, or GFAA analysis is performed to measure the concentration of silicon element in the precipitate. Finally, the original concentration of silicon element in the original sample is obtained by calculation based on the concentration of the silicon element in the precipitate and the dilution ratio thereof.

In the above Example 2, MEA is the active species in the sample, silicon element is the target substance to be detected, iodomethane serves to deactivate MEA, ferric chloride serves to co-precipitate the silicon element into the precipitate (or the solid species), and the deactivated species of MEA is dissolved in the upper liquid portion that is descanted.

### EXAMPLE 3

100 mL of an aqueous solution (original sample) containing ethylenediamine and an unknown amount of silicon element is cooled in an ice bath. When the temperature of the aqueous solution (or the sample) reaches 0° C., excess dimethyl carbonate (6-12 equivalents with respect to 1.0 equivalent of ethylenediamine) is added into the solution dropwise with continuously stirring. The mixture is then removed from the ice bath, and the reaction continues at room temperature for 30 minutes. After the reaction is completed, the solution is then acidified to pH 3 with diluted sulfuric acid and then monitored by a non-glass type pH meter such as ion sensitive field effect transistor (ISFET) semiconductor probe. Next, 5 mL of an aqueous solution including 100 mg of cerium (IV) sulfate is added in the acidified solution, and then diluted potassium hydroxide solution is added to tune the pH value of the solution to pH 8.0 with continuously stirring for 10 minutes to form a suspension in the solution. The solution including the suspension is centrifuged for 10 minutes with a 5000-g force, the upper liquid portion is then descanted, the remained precipitate is dissolved with diluted hydrofluoric acid (HF), and general procedure of ICP-MS, ICP-OES, or GFAA analysis is performed to measure the concentration of silicon element in the precipitate. Finally, the original concentration of silicon element in the original sample is obtained by calculation based on the concentration of the silicon element in the precipitate and the dilution ratio thereof.

In the above Example 3, ethylenediamine is the active species in the sample, silicon clement is the target substance to be detected, dimethyl carbonate serves to deactivate ethylenediamine, cerium (IV) sulfate serves to co-precipitate the silicon element into the precipitate (or the solid species), and the deactivated species of ethylenediamine is dissolved in the upper liquid portion that is descanted.

### EXAMPLE 4

100 mL of an aqueous solution (original sample) containing ethylenediamine and an unknown amount of iron element is cooled in an ice bath. When temperature of the aqueous solution (or the sample) reaches 0° C., excess diethyl sulfate (3-6 equivalents with respect to 1.0 equivalent of ethylenediamine) is added into the solution dropwise with continuously stirring. The mixture is then removed from the ice bath, and the reaction continues at room temperature for 30 minutes. After the reaction is completed, the solution is then acidified to pH 3 with diluted sulfuric acid and then monitored by a non-glass type pH meter such as ion sensitive field effect transistor (ISFET) semiconductor probe. Next, 1.0 mL of tetraethoxysilane is added in the acidified solution, and then aqueous ammonia is added to tune the pH value of the solution to pH 11.0 with continuously stirring for 30 minutes to form a suspension in the solution. The solution including the suspension is centrifuged for 10 minutes with a 5000-g force, the upper liquid portion is then descanted, the remained precipitate is dissolved with diluted hydrofluoric acid (HF), and general procedure of ICP-MS, ICP-OES, or GFAA analysis is performed to measure the concentration of iron element in the precipitate. Finally, the original concentration of iron element in the original sample is obtained by calculation based on the concentration of the iron element in the precipitate and the dilution ratio thereof.

In the above Example 4, ethylenediamine is the active species in the sample, iron clement is the target substance to be detected, diethyl sulfate serves to deactivate ethylenediamine, tetraethoxysilane serves to co-precipitate the iron element into the precipitate (or the solid species), and the deactivated species of ethylenediamine is dissolved in the upper liquid portion that is descanted.

Some embodiments of the present disclosure provide method for detecting a target substance. The method includes providing a sample including the target substance and an active species; converting the active species into a deactivated species; adding a reactive agent into the sample to form a solid species including the target substance; separating the solid species from the deactivated species by solid-liquid separation; and determining a concentration of the target substance in the sample by measuring a concentration of the target substance in the solid species.

Some embodiments of the present disclosure provide method for detecting a target substance. The method includes providing a solution including the target substance and an active species; reacting the active species with a deactivating agent to form a deactivated species in the solution; coprecipitating the solution to form a solid species including the target substance; separating the solid species from the deactivated species; and determining a concentration of the target substance in the solution by measuring a concentration of the target substance in the solid species.

Some embodiments of the present disclosure provide method for detecting a target substance. The method includes providing an aqueous solution including the target substance and an organic compound; deactivating the organic compound to form a deactivated organic compound; concentrating the target substance by coprecipitating the aqueous solution to form a solid species including the target substance and substantially free of the deactivated organic compound; and determining a concentration of the target substance in the aqueous solution by measuring a concentration of the target substance in the solid species.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for detecting a target substance, comprising:
providing a sample comprising the target substance and an active species;
converting the active species into a deactivated species;
adding a reactive agent into the sample to form a solid species comprising the target substance;
separating the solid species from the deactivated species by solid-liquid separation; and
determining a concentration of the target substance in the sample by measuring a concentration of the target substance in the solid species.

2. The method of claim 1, wherein the active species comprises an organic compound having a chelating functional group, and converting the active species into the deactivated species comprises adding a deactivating agent into the sample to react with the chelating functional group.

3. The method of claim 2, wherein the deactivating agent comprises an alkylating agent, an acylating agent, an acetalizing agent, or a combination thereof.

4. The method of claim 2, wherein the active species comprises alcohol, sulfide, amine, phosphate, or a combination thereof.

5. The method of claim 1, wherein the reactive agent is substantially non-reactive with the deactivated species and substantially reactive with the target substance.

6. The method of claim 5, wherein the reactive agent is substantially reactive with the active species.

7. The method of claim 5, wherein the reactive agent comprises a metal salt comprising a metal selected from the group consisting of cerium, aluminum, iron, lanthanum, zirconium, titanium, tin, barium, strontium, and cobalt.

8. A method for detecting a target substance, comprising:
providing a solution comprising the target substance and an active species;
reacting the active species with a deactivating agent to form a deactivated species in the solution;
coprecipitating the solution to form a solid species comprising the target substance;
separating the solid species from the deactivated species; and
determining a concentration of the target substance in the solution by measuring a concentration of the target substance in the solid species.

9. The method of claim 8, wherein the active species comprises an organic component having a hydroxyl group, a mercapto group, an amino group, a phosphono group, or a combination thereof.

10. The method of claim 8, further comprising:
adding a cryosolvent into the solution; and
lowering a temperature of the solution during the coprecipitating, wherein the cryosolvent remains in a liquid state when lowering the temperature of the solution.

11. The method of claim 8, wherein coprecipitating the solution comprises adding a metal salt into the solution, and the metal salt comprises a metal selected from the group consisting of cerium, aluminum, iron, lanthanum, zirconium, titanium, tin, barium, strontium, and cobalt.

12. The method of claim 11, wherein the target substance comprises silica nanoparticles, silicone oil, silicates, silanol, or a combination thereof.

13. The method of claim 8, wherein the target substance comprises a first element, coprecipitating the solution comprises adding a compound including a second element different from the first element into the solution, and the first element and the second element independently comprise elements selected from the group consisting of cerium, aluminum, iron, lanthanum, zirconium, titanium, tin, barium, strontium, cobalt, and silicon.

14. The method of claim 8, wherein the deactivating agent comprises an alkylating agent, an acylating agent, an acetalizing agent, or a combination thereof.

15. A method for detecting a target substance, comprising:
providing an aqueous solution comprising the target substance and an organic compound;
deactivating the organic compound to form a deactivated organic compound;
concentrating the target substance by coprecipitating the aqueous solution to form a solid species comprising the target substance and substantially free of the deactivated organic compound; and
determining a concentration of the target substance in the aqueous solution by measuring a concentration of the target substance in the solid species.

16. The method of claim 15, wherein deactivating the organic compound comprises deactivating a chelating ability of the organic compound with the target substance.

17. The method of claim 15, wherein concentrating the target substance is free of evaporating the aqueous solution.

18. The method of claim 15, wherein deactivating the organic compound comprises reacting the organic compound with a deactivating agent comprising an alkylating agent, an acylating agent, an acetalizing agent, or a combination thereof.

19. The method of claim 15, wherein coprecipitating the aqueous solution comprises adding a metal salt into the aqueous solution, wherein the metal salt comprises a water soluble anion.

20. The method of claim 19, wherein coprecipitating the aqueous solution further comprises:
cooling down the aqueous solution to a temperature lower than about 10° C.; and
adding an organic solvent into the aqueous solution when cooling down, wherein the organic solvent remains in a liquid state when cooling down the aqueous solution.
